(19) United States
(12) Patent Application Publication
(10) Pub. No.: US 2026/0003960 A1
(43) Pub. Date: Jan. 1, 2026

(54) Method for Enhancing a Model, Method for Running a Model, Method to Maintain a Model, Apparatus for Using a Model, Apparatus for Maintaining a Model, and Computer Program

(71) Applicant: Intel Corporation, Santa Clara, CA (US)

(72) Inventors: Yaron KLEIN, Rosh Haayin (IL); Dan HOROVITZ, Rishon Lezion (IL); Omer BEN-SHALOM, Rishon Lezion (IL)

(21) Appl. No.: 19/263,684

(22) Filed: Jul. 9, 2025

(51) Int. Cl. G06F 21/55

(52) U.S. Cl. CPC G06F 21/554

(57) ABSTRACT

Provided is a method for enhancing a model for an edge device (102). The method comprises analyzing data (310) on the edge devices to generate features for the model. Furthermore, the method involves transmitting the features (320) from the edge devices (102) to a centralized server (114), and updating the model (330) based on the features using machine learning. Additionally, the method includes distributing (340) the updated model to the edge devices.

### FIELD

The present disclosure relates to methods for enhancing, running, and maintaining models for edge devices, apparatus for using and maintaining models for edge devices, computer programs, and non-transitory machine-readable storage media.

### BACKGROUND

In contemporary computing environments, the proliferation of edge devices, such as laptops, mobile phones, and Internet of Things (IoT) devices, presents unique challenges for maintaining effective and up-to-date computational models, particularly in domains like cybersecurity. These devices often operate with constraints on computational resources and may handle sensitive data, making traditional centralized model management approaches problematic.

Conventional centralized models, for instance in cybersecurity, may involve transferring substantial amounts of raw data from edge devices to a central server for analysis. This may consume significant bandwidth and power due to the transmission of large amounts of raw data. Furthermore, the sheer volume of data from numerous edge devices can lead to scalability issues for the central server.

Local models running solely on edge devices are often limited by the computational capabilities of the individual devices. This may restrict the complexity and effectiveness of the models. Moreover, such local models may lack the broader insights gained from aggregated data across multiple devices, potentially leading to inconsistent performance or an inability to detect novel or widespread patterns.

Hybrid approaches have attempted to balance these concerns but can introduce complexity in managing and coordinating local and centralized resources and may still require the transmission of large amounts of data. There is a demand for improved techniques for managing models on edge devices that can address concerns related to data size, transmission bandwidth and power consumption, while still allowing for robust and adaptive model performance. The present disclosure aims to satisfy this demand.

### BRIEF DESCRIPTION OF THE FIGURES

Some examples of apparatuses and/or methods will be described in the following by way of example only, and with reference to the accompanying figures, in which

FIG. 1 illustrates an example of an overall system architecture;

FIG. 2 illustrates an example of detailed system components;

FIG. 3 illustrates an example of a model enhancement flowchart;

FIG. 4 illustrates an example of a model running flowchart;

FIG. 5 illustrates an example of a model maintenance flowchart;

FIG. 6 illustrates an example of an edge device apparatus; and

FIG. 7 illustrates an example of a server-side apparatus.

### DETAILED DESCRIPTION

Some examples are now described in more detail with reference to the enclosed figures. However, other possible examples are not limited to the features of these embodiments described in detail. Other examples may include modifications of the features as well as equivalents and alternatives to the features. Furthermore, the terminology used herein to describe certain examples should not be restrictive of further possible examples.

Throughout the description of the figures same or similar reference numerals refer to same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form, such as “a”, “an” and “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

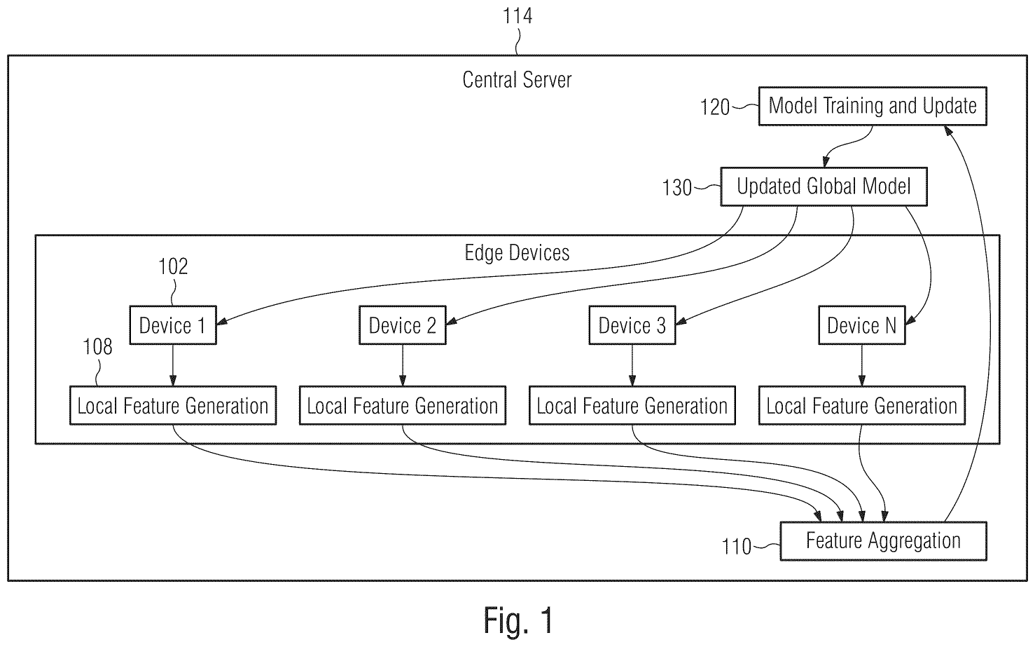

FIG. 1 illustrates an example of an overall system architecture for enhancing and distributing a model. The system may include a Central Server 114 and one or more Edge Devices 102. An “Edge Device” such as Edge Device 102, generally refers to a computing device located at or near the periphery of a network, often closer to where data is generated or consumed. Edge devices typically possess local processing capabilities and can operate with some degree of autonomy or in conjunction with a centralized system. Examples of edge devices can include, but are not limited to, laptops, mobile phones, Internet of Things (IoT) devices such as sensors or actuators, embedded systems in vehicles or industrial equipment, and smart home appliances. In the context of FIG. 1, Edge Devices 102 (Device 1, Device 2, Device 3, up to Device N) represent such distributed computing entities.

Each Edge Device 102 performs Local Feature Generation by a Feature Generation Module 108. Features in this context, and generally in machine learning, are individual measurable properties or characteristics of a phenomenon being observed. They are derived or extracted from raw data and are intended to be informative and non-redundant, facilitating learning tasks. For example, if the raw data is network traffic logs, features could include the number of packets transmitted, the duration of a connection, or the frequency of specific protocol usage. If the data pertains to system performance, features might include CPU utilization, memory access patterns, or API call sequences. Local Feature Generation 108 signifies that this process of creating features from data occurs on the Edge Device 102 itself.

The features generated by Edge Devices 102 may be transmitted for Feature Aggregation 110. This aggregation typically occurs at a “Centralized Server,” such as Central Server 114. A centralized server is generally one or more computing systems that act as a central repository or processing hub for data or operations from multiple distributed clients or devices. It often has more substantial computational power, storage capacity, and network bandwidth compared to individual edge devices. Central Server 114 is depicted as such a central entity.

Central Server 114 includes a Model Training and Update component 120. This component uses the aggregated features from Feature Aggregation 110 to train or update a global model. A model, in this context, refers to a computational representation, often mathematical or algorithmic, learned from data, which can be used to make predictions, classifications, decisions, or to uncover patterns. Examples include statistical models, machine learning models (such as neural networks, decision trees, support vector machines), or other analytical constructs. The Model Training and Update component 120 employs machine learning techniques. Machine learning is a subfield of artificial intelligence where computer systems use statistical techniques to learn from data and improve their performance on a specific task over time without being explicitly programmed for each case. This can involve various algorithms for tasks like classification, regression, clustering, or anomaly detection.

An Updated Global Model 130 is distributed from Central Server 114 back to Edge Devices 102. This architecture facilitates a system where edge devices contribute to the refinement of a global model, which is then disseminated back, potentially enhancing the capabilities of each edge device.

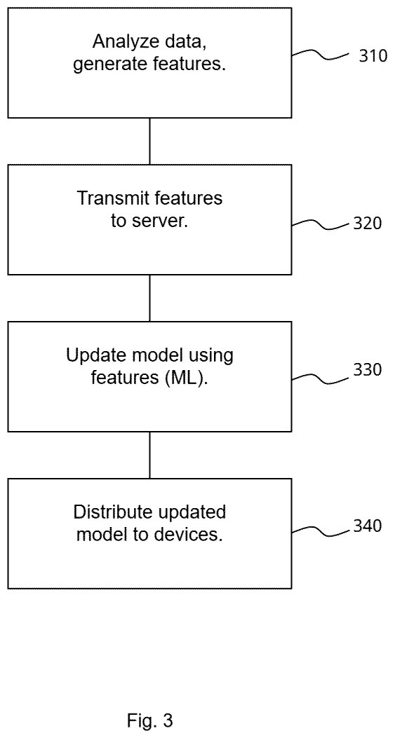

The System illustrated in FIG. 1 serves to perform a method for enhancing a model for an edge device as illustrated in FIG. 3. This method comprises analyzing data (step 310) on the edge devices to generate features for the model, which can allow for localized data processing and may reduce the need to transmit extensive raw data, potentially preserving bandwidth and enhancing privacy. The method also comprises transmitting the features (step 320) from the edge devices to a centralized server, which can facilitate the aggregation of information from diverse sources, enabling the creation of a more comprehensive understanding for model improvement. Furthermore, the method comprises updating the model (step 330) based on the features using machine learning, which can allow the model to learn from new, aggregated data and adapt its performance over time, leading to a more robust model. Additionally, the method comprises distributing the updated model to the edge devices (step 340), which can ensure edge devices benefit from collective learning and maintain up-to-date model versions for improved local performance.

In a further embodiment of a method for enhancing a model for an edge device, the features are generated such that they are non-sensitive. This approach can further enhance user privacy and data security by ensuring that the information transmitted does not contain private or directly identifiable data, which can build user trust and meet regulatory requirements. Non-sensitive features refer to representations of data that have been generated or transformed in such a way that they do not, by themselves, reveal private, confidential, or personally identifiable information about an individual, system, or the underlying raw data from which they were derived. The goal of using non-sensitive features is to enable data analysis, machine learning model training, or information sharing while mitigating privacy risks. This can be achieved through various approaches and techniques. For instance, features can be made non-sensitive through aggregation, where data from multiple events are summarized. Another approach is abstraction or generalization, where specific details are replaced with broader categories or indicators (e.g., classifying a system event as an “anomaly” rather than detailing the specific anomalous parameters, or using metadata like file type counts instead of file contents). Techniques like differential privacy, which involve adding carefully calibrated noise, or feature hashing for categorical data, can also be used to produce features with reduced sensitivity while keeping utility for analysis.

In certain embodiments of a method for enhancing a model for an edge device, the features are transmitted using a secure communication protocol. Utilizing secure communication protocols can protect the integrity and confidentiality of the features during transmission, which is important for maintaining the security of the system and the data. A secure communication protocol generally refers to a defined set of rules and conventions that govern the exchange of data between computing systems in a way that protects the information from unauthorized access, modification, or disruption. Such protocols ensure one or more security properties, including confidentiality (preventing eavesdropping by encrypting data), integrity (ensuring data has not been altered in transit), and authentication (verifying the identity of the communicating parties). These protocols often employ cryptographic techniques and standardized procedures to establish secure channels over potentially insecure networks. Some widely established examples of secure communication protocols include Transport Layer Security (TLS) and its predecessor Secure Sockets Layer (SSL), which are commonly used to secure web communication (HTTPS), email, and other network traffic. Other examples are Secure Shell (SSH) for secure remote login and file transfer, and various Virtual Private Network (VPN) protocols like IPsec (Internet Protocol Security) or OpenVPN, which create secure tunnels between networks or devices.

According to other embodiments of a method for enhancing a model for an edge device, transmitting the features further comprises encrypting the features. Encrypting the features before transmission can provide an additional layer of security for the transmitted feature data, safeguarding it even if the communication channel is compromised. Encryption is the process of converting information or data into a code, especially to prevent unauthorized access. The feature data is transformed using an algorithm (cipher) and a key, making it unreadable to anyone without the corresponding decryption key. This protects the features during their transit between devices and servers.

Some embodiments of a method for enhancing a model for an edge device further comprise at least one of normalizing, scaling, or transforming raw data into the features. Such data preprocessing steps can improve the quality of the features and the performance of the machine learning process by ensuring data consistency and suitability for the learning algorithms.

In some embodiments of a method for enhancing a model for an edge device, the model is a security model and the features are indicative of potential cyber-attacks. Applying the method to security models in this way can enhance the ability to detect and respond to cyber threats on edge devices by leveraging distributed learning for a more comprehensive security posture.

In an embodiment of a security-focused method, the data is analyzed to generate features that are indicative of at least one of call stack anomalies, unusual memory access patterns, rare API calls, execution timing patterns, code injection indicators, or process communication anomalies. These specific types of features can be particularly effective in identifying sophisticated or subtle cyber-attack behaviors that might otherwise go unnoticed by more generic detection methods, leading to improved threat detection accuracy. Those types of features can also be designed to be non-sensitive, as they focus on behavioral patterns or deviations rather than the specific content of data or user activity.

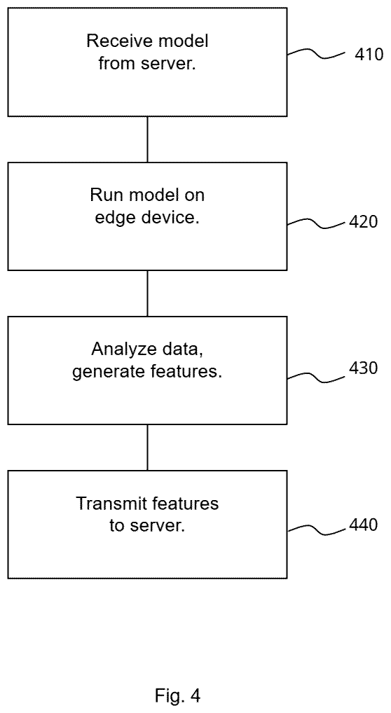

An embodiment relates to a method for running a model on an edge device as illustrated in FIG. 4. This method comprises receiving the model from a centralized server (step 410), which allows the edge device to obtain the latest or most appropriate model version, ensuring it operates with up-to-date intelligence. The method also comprises running the model on the edge device (step 420), enabling local execution and decision-making, which can provide faster response times and offline functionality. Furthermore, the method comprises analyzing data on the edge device (step 430) to generate features for the model, facilitating local data processing and feature extraction, which can be used for immediate local tasks and also contribute to global model improvements. Additionally, the method comprises transmitting the features (step 440) from the edge device to the centralized server, which allows the edge device to contribute its locally derived insights, which can be used for ongoing enhancement of the global model, creating a feedback loop for continuous learning.

A further embodiment of a method for running a model on an edge device comprises at least one of normalizing, scaling, or transforming raw data into the features. This can improve the quality of the locally generated features on the edge device, leading to more accurate local model performance and more valuable contributions to the central model.

Another embodiment of a method for running a model on an edge device further comprises receiving an updated model from the centralized server. This can allow the edge device to refresh its model periodically or on demand, benefiting from updates made based on broader data and ensuring continued optimal performance.

In certain embodiments of a method for running a model on an edge device, the features are generated such that they are non-sensitive. This can help to maintain user privacy on the edge device while still allowing the device to contribute valuable, anonymized insights for model improvement.

In other embodiments of a method for running a model on an edge device, the features are transmitted using a secure communication protocol. This may ensure secure contribution of local findings from the edge device to the server, protecting the data in transit.

According to some embodiments of a method for running a model on an edge device, transmitting the features further comprises encrypting the features. This can add a further layer of security to the feature data transmitted from the edge device, enhancing data protection.

In particular embodiments of a method for running a model on an edge device, the model is a security model, and the features are indicative of potential cyber-attacks. This allows the edge device to actively participate in a distributed cybersecurity framework by running a security model locally and contributing relevant security-related features.

In a specific embodiment of a security-focused method for running a model, the data is analyzed to generate features that are indicative of at least one of call stack anomalies, unusual memory access patterns, rare API calls, execution timing patterns, code injection indicators, or process communication anomalies. Generating such specific security-oriented features locally on the edge device can aid in early and nuanced threat detection directly at the potential point of attack.

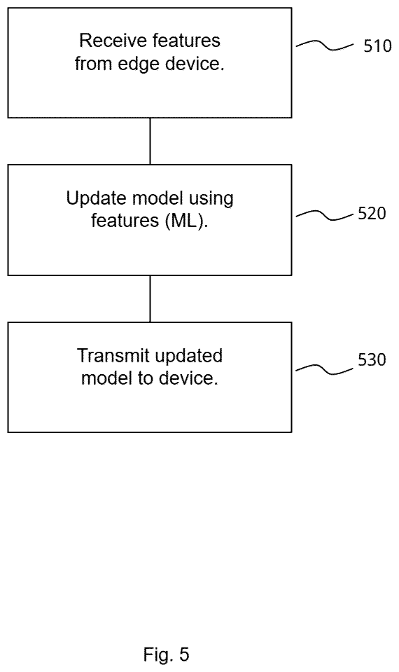

An embodiment relates to a method to maintain a model for an edge device as illustrated in FIG. 5, which may be typically performed at a centralized location. This method comprises receiving features from the edge device (step 510), which allows the central system to gather insights and observations from distributed sources, providing a broader dataset for model refinement. The method also comprises updating the model (step 520) based on the features using machine learning, enabling continuous model improvement and adaptation based on real-world data from multiple edge devices. Additionally, the method comprises transmitting the updated model (step 530) to the edge device, which ensures the edge device benefits from the centralized updates, thereby improving its local performance and effectiveness.

In a further embodiment of a method to maintain a model for an edge device, the model is a security model, and the features are indicative of potential cyber-attacks. This focuses the model maintenance process on enhancing cybersecurity capabilities across the distributed system of edge devices.

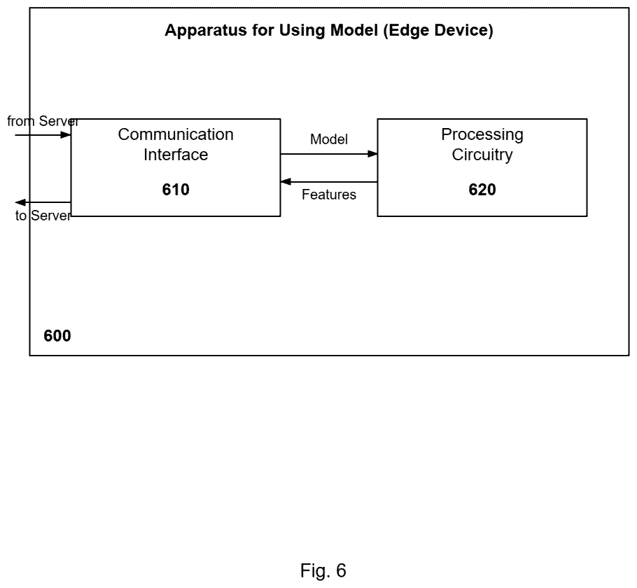

An embodiment relates to an apparatus for using a model on an edge device as illustrated in FIG. 6. The apparatus comprises a communication interface 610 configured to receive the model from a centralized server, which allows the apparatus to obtain the necessary model for its operations, ensuring it has the correct tools for its tasks. The apparatus also comprises processing circuitry 620 configured to run the model on the edge device and to analyze data on the edge device to generate features for the model. This configuration enables local execution of the model and local feature generation, which can provide for rapid responses and reduced reliance on network connectivity for these core functions. The communication interface 610 is further configured to transmit the features from the edge device to the centralized server, facilitating participation in a federated or distributed learning system by allowing the apparatus to contribute its findings for global model improvement.

In a further embodiment of an apparatus for using a model on an edge device, the processing circuitry is further configured to normalize, scale, or transform raw data to generate the features. According to another embodiment of an apparatus for using a model on an edge device, the communication interface is further configured to receive an updated model from the centralized server. Some embodiments of an apparatus for using a model on an edge device provide that the processing circuitry is configured to generate the features such that they are non-sensitive.

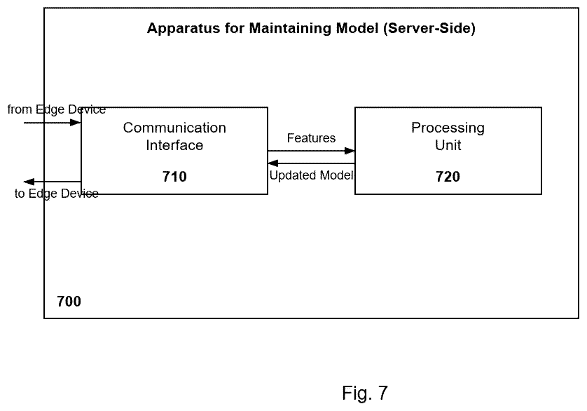

An embodiment relates to an apparatus for maintaining a model for an edge device as illustrated in FIG. 7. This may be a centralized apparatus. The apparatus comprises a communication interface 710 configured to receive features from the edge device, enabling the apparatus to collect data and insights from distributed edge devices, forming a basis for model updates. The apparatus also comprises a processing unit 720 configured to update the model based on the features using machine learning, which facilitates centralized model improvement and adaptation using the aggregated features. The communication interface 710 is further configured to transmit the updated model to the edge device, allowing the edge devices in the system to benefit from the centrally managed updates, distributing improvements across the network.

In an embodiment of an apparatus for maintaining a model for an edge device, the model is a security model, and the features are indicative of potential cyber-attacks. This focuses the apparatus on maintaining and improving cybersecurity models, enhancing the overall security posture of the system it serves.

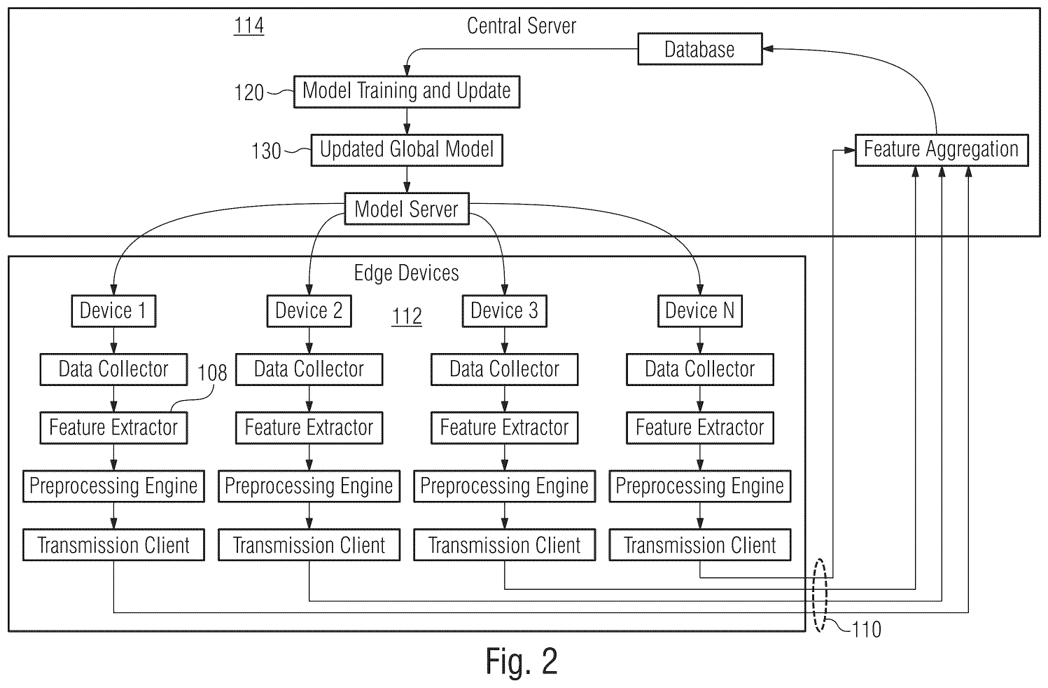

FIG. 2 illustrates an example of more detailed system components that may be part of the architecture shown in FIG. 1. The Edge Devices, represented by the encompassing block 112 which denotes the functional components within such devices, may each include several modules. A Data Collector module is configured to gather raw data. This raw data can originate from various sources on or accessible to the edge device, for example, system activity logs, network traffic data, sensor outputs, user interaction data, or application telemetry. Feature Extractor module/Feature Generation Module 108 processes this raw data to generate features. This process might involve various techniques such as calculating statistical measures (e.g., mean, variance), applying signal processing methods (e.g., filters, transforms), or using domain-specific rules to identify relevant patterns. A Preprocessing Engine may further refine these features. Preprocessing can include normalizing data, which often means adjusting values measured on different scales to a notionally common scale, for instance, scaling values to a range between 0 and 1 or transforming them to have zero mean and unit variance. Scaling can refer to changing the range of data without necessarily changing the shape of its distribution. Transforming raw data into features can also involve more complex operations like dimensionality reduction (e.g., Principal Component Analysis), feature construction (creating new features from existing ones), or converting data types (e.g., text to numerical vectors). A Transmission Client module may be responsible for transmitting the processed features, such as features to Central Server 114. This transmission may utilize a secure communication protocol, which is a set of rules and procedures designed to ensure the confidentiality, integrity, and authenticity of data exchanged between communicating parties. Examples include Transport Layer Security (TLS) or Secure Shell (SSH).

Central Server 114 is shown with a Feature Aggregation module that receives and combines features 110 from the various Edge Devices 112. A Database may be present for storing aggregated features, model parameters, or other relevant system data. A Model Server could be used for managing and serving different versions of models. The Model Training and Update module 120 uses the aggregated features for model refinement or training. The Updated Global Model 130 is then made available for distribution.

FIG. 3 is a flowchart illustrating an example of a method 100 for enhancing a model. At step 310, the method involves analyzing data and generating features. This analysis of data, such as data 108, may involve various techniques to understand the data and extract meaningful information, which is then used to generate features. This step occurs on edge devices. At step 320, the method involves transmitting features to a server, which may be Central Server 114. At step 330, the method involves updating a model using the received features and machine learning. This allows the model to adapt and potentially improve its performance. At step 340, the method involves distributing the updated model to devices, such as Edge Devices 102, enabling them to use the enhanced model.

FIG. 4 is a flowchart illustrating an example of a method for running a model on an edge device. At step 410, the method involves receiving a model, such as model 410, from a server. At step 420, the method involves running the model, such as model 420, on the edge device. This means the edge device uses the received model to perform its designated tasks, such as making predictions or classifications based on local inputs. At step 430, the method involves analyzing data, such as data 430, on the edge device and generating features for the model. At step 440, the method involves transmitting these features, such as features 440, from the edge device to the server, potentially for further global model enhancement.

FIG. 5 is a flowchart illustrating an example of a method to maintain a model for an edge device. This method might be executed on a centralized server 114. At step 510, the method involves receiving features, such as features 510, from an edge device. At step 520, the method involves updating the model, such as model 520, based on these received features using machine learning. At step 530, the method involves transmitting the updated model, such as updated model 530, to the edge device.

FIG. 6 is a block diagram of an example apparatus 600 for using a model on an edge device. Apparatus 600 may comprise a Communication Interface 610 and Processing Circuitry 620. The Communication Interface 610 enables the apparatus to communicate with external entities. It can include physical components for signal transmission and reception (e.g., antennas, ports) and logical components for managing communication protocols (e.g., network stacks). Communication Interface 610 is configured to receive a model from a centralized server and to transmit features to that server. Processing Circuitry 620 comprises one or more electronic circuits designed to execute instructions or perform computations. This can include general-purpose processors (like CPUs or GPUs), digital signal processors (DSPs), or application-specific hardware (like ASICs or FPGAs). Processing Circuitry 620 is configured to run the received model on the edge device and to analyze data available on the edge device to generate features for the model. These features are then transmitted via Communication Interface 610.

FIG. 7 is a block diagram of an example apparatus 700 for maintaining a model for an edge device, which may be a server-side apparatus. Apparatus 700 comprises a Communication Interface 710 and a Processing Unit 720. Communication Interface 710 is configured to receive features from an edge device and to transmit an updated model to an edge device. Processing Unit 720 is configured to update the model based on the received features using machine learning.

Features may be non-sensitive, meaning they are generated or transformed so as not to reveal private or directly identifiable information. This can be achieved by techniques such as aggregation (summarizing data from multiple users or events), anonymization (removing or obscuring identifiers), generalization (making data less precise), or by extracting abstract behavioral patterns (e.g., an unusual sequence of system calls rather than the content of the calls). For instance, instead of transmitting a user's exact browsing history (sensitive), a non-sensitive feature might be the count of visits to “.com” versus “.org” domains in a given period, or a generalized category of websites visited.

A model may be a security model. This is a model specifically designed for cybersecurity purposes, such as detecting malware, identifying network intrusions, predicting system vulnerabilities, or flagging anomalous user or system behavior that might indicate a cyber-attack. Examples include machine learning classifiers trained to distinguish between malicious and benign files, or anomaly detection systems that learn normal network traffic patterns to identify deviations. Features indicative of potential cyber-attacks, such as call stack anomalies, unusual memory access patterns, rare API calls, execution timing patterns, code injection indicators, or process communication anomalies, are specific examples of information that such a security model might use or that might be generated to train such a model. Call stack anomalies might refer to unexpected sequences or depths in the function call stack of a program, which could indicate buffer overflows or other exploitation techniques. Unusual memory access patterns could be accesses to restricted memory regions or patterns of reads/writes that deviate from normal program behavior, potentially signaling malware activity. Rare API calls might involve a program using system functions it normally does not or using them in an unusual sequence or with unusual parameters, which could be a sign of malicious intent. Execution timing patterns could refer to deviations in the time taken for certain operations or processes, which might indicate code injection or interference. Code injection indicators are signs that malicious code has been inserted into a running process, such as unexpected new threads or modules. Process communication anomalies could involve processes communicating in unusual ways or with unexpected other processes, potentially indicating a coordinated attack or data exfiltration.

While the preceding description has often been set in the context of security models and cyber-attack detection, it will be understood that the disclosed methods and apparatuses for enhancing, running, and maintaining models on edge devices through federated feature extraction and model updates can be applied to a wide variety of other fields and use cases. The core principles of local feature generation on edge devices, transmission of these (potentially non-sensitive) features to a centralized server, server-side model updating using machine learning based on aggregated features, and distribution of the updated model back to the edge devices are broadly applicable wherever distributed learning and model personalization or adaptation at the edge are beneficial.

For example, the disclosed systems and methods may be employed in real-time deepfake detection. In such an application, edge devices, which could be user devices or specialized processing nodes, might be equipped with deepfake detection technology. These edge devices could analyze video data locally to identify characteristics indicative of deepfake content. Features such as pixel-level inconsistencies between video frames, temporal artifacts that are common in synthesized video, or audio-visual mismatches (e.g., lip movements not corresponding to the audio) may be generated locally on the edge device. These features can be designed to be non-sensitive, focusing on the statistical or structural properties that indicate a deepfake without requiring the transmission of the actual, potentially private, video content to a central server. The locally generated features from many such edge devices can then be transmitted to a centralized server. The server can aggregate these features and use them to update a global deepfake detection model, potentially improving its accuracy and robustness against new or evolving deepfake generation techniques. This updated global model can then be distributed back to the edge devices, enhancing their local detection capabilities.

Another application area may be in enhancing data security and fraud detection in banking environments. Edge devices within a banking context, such as ATMs, point-of-sale terminals, or even customer computing devices interacting with banking services, could analyze network traffic patterns, user behavior, and transaction characteristics locally. Features indicative of potential data breaches or fraudulent activities, such as unusual data access patterns (e.g., a user account accessing files it normally does not), unexpected data transfers (e.g., large data exfiltration attempts), or anomalies in transaction behavior (e.g., transactions that deviate significantly from a user's typical spending habits or geographic location), may be generated on these edge devices. These features, which can be designed to be non-sensitive summaries or indicators, can be sent to a centralized server. The server can then update a global security or fraud detection model based on the aggregated features from numerous banking edge points. The improved model can then be distributed back, allowing the edge devices to more effectively identify and potentially prevent attacks targeting sensitive banking data or fraudulent transactions in real-time.

Furthermore, the principles may be applied to customer feedback analysis in retail or service environments. Edge devices, such as kiosks, mobile applications used by customers, or devices used by staff, could locally analyze customer feedback provided through various channels (e.g., text input, voice comments). Features like common keywords used in feedback, sentiment polarity (positive, negative, neutral) derived from language analysis, and the frequency of specific topics or complaints can be generated locally. Transmitting these non-sensitive, aggregated features to a central server allows for the updating of a global model that understands customer sentiment and trends. This updated model, when distributed back to the edge or made accessible to relevant systems, can enable businesses to react more promptly and effectively to customer feedback, potentially improving customer satisfaction, service quality, and product development by identifying emerging issues or preferences across a distributed customer base.

These examples are illustrative and not exhaustive. The framework described for distributed model enhancement using local feature generation can be adapted to many other domains where intelligent models operate on edge devices and can benefit from collective learning while addressing concerns such as privacy, latency, and bandwidth.

Example 1 is a method for enhancing a model for an edge device, comprising: analyzing data on the edge devices to generate features for the model; transmitting the features from the edge devices to a centralized server; updating the model based on the features using machine learning; and distributing the updated model to the edge devices.

Another example (e.g. Example 2) relates to Example 1 and further comprises the features being generated such that they are non-sensitive.

Another example (e.g. Example 3) relates to any one of the preceding examples (e.g., Example 1 or Example 2) and further comprises the features being transmitted using a secure communication protocol.

Another example (e.g. Example 4) relates to any one of the preceding examples (e.g., Example 1, Example 2, or Example 3) and further comprises transmitting the features further comprising encrypting the features.

Another example (e.g. Example 5) relates to any one of the preceding examples (e.g., Examples 1 through 4) and further comprises at least one of normalizing, scaling or transforming raw data into the features.

Another example (e.g. Example 6) relates to any one of the preceding examples (e.g., Examples 1 through 5) and further comprises the model being a security model and the features being indicative of potential cyber-attacks.

Another example (e.g. Example 7) relates to Example 6 and further comprises the data being analyzed to generate features that are indicative of at least one of call stack anomalies, unusual memory access patterns, rare API calls, execution timing patterns, code injection indicators, or process communication anomalies.

Example 8 is a method for running a model on an edge device, comprising: receiving the model from a centralized server; running the model on the edge device; analyzing data on the edge device to generate features for the model; and transmitting the features from the edge device to the centralized server.

Another example (e.g. Example 9) relates to Example 8 and further comprises at least one of normalizing, scaling or transforming raw data into the features.

Another example (e.g. Example 10) relates to Example 8 or Example 9 and further comprises receiving an updated model from the centralized server.

Another example (e.g. Example 11) relates to any one of the preceding examples (e.g., Examples 8 through 10) and further comprises the features being generated such that they are non-sensitive.

Another example (e.g. Example 12) relates to any one of the preceding examples (e.g., Examples 8 through 11) and further comprises the features being transmitted using a secure communication protocol.

Another example (e.g. Example 13) relates to any one of the preceding examples (e.g., Examples 8 through 12) and further comprises transmitting the features further comprising encrypting the features.

Another example (e.g. Example 14) relates to any one of the preceding examples (e.g., Examples 8 through 13) and further comprises the model being a security model, and the features being indicative of potential cyber-attacks.

Another example (e.g. Example 15) relates to Example 14 and further comprises the data being analyzed to generate features that are indicative of at least one of call stack anomalies, unusual memory access patterns, rare API calls, execution timing patterns, code injection indicators, or process communication anomalies.

Example 16 is a method to maintain a model for an edge device, comprising: receiving features from the edge device; updating the model based on the features using machine learning; and transmitting the updated model to the edge device.

Another example (e.g. Example 17) relates to Example 16 and further comprises the model being a security model, and the features being indicative of potential cyber-attacks.

Example 18 is a computer program having a program code causing, when the code is executed, to perform a method according to any one of the preceding examples (e.g., Examples 1 through 17).

Example 19 is an apparatus for using a model on an edge device, comprising: a communication interface configured to receive the model from a centralized server; processing circuitry configured to run the model on the edge device; and to analyze data on the edge device to generate features for the model; wherein the communication interface is further configured to transmit the features from the edge device to the centralized server.

Another example (e.g. Example 20) relates to Example 19 and further comprises the processing circuitry being further configured to normalize, scale or transform raw data to generate the features.

Another example (e.g. Example 21) relates to Example 19 or Example 20 and further comprises the communication interface being further configured to receive an updated model from the centralized server.

Another example (e.g. Example 22) relates to any one of the preceding examples (e.g., Examples 19 through 21) and further comprises the processing circuitry being configured to generate the features such that they are non-sensitive.

Another example (e.g. Example 23) relates to any one of the preceding examples (e.g., Examples 19 through 22) and further comprises the communication interface being configured to transmit the features using a secure communication protocol.

Another example (e.g. Example 24) relates to any one of the preceding examples (e.g., Examples 19 through 23) and further comprises the communication interface being further configured to encrypt the features.

Another example (e.g. Example 25) relates to any one of the preceding examples (e.g., Examples 19 through 24) and further comprises the model being a security model, and the features being indicative of potential cyber-attacks.

Another example (e.g. Example 26) relates to Example 25 and further comprises the processing circuitry being configured to generate features that are indicative of at least one of call stack anomalies, unusual memory access patterns, rare API calls, execution timing patterns, code injection indicators, or process communication anomalies.

Example 27 is an apparatus for maintaining a model for an edge device, comprising: a communication interface configured to receive features from the edge device; a processing unit configured to update the model based on the features using machine learning; wherein the communication interface is further configured to transmit the updated model to the edge device.

Another example (e.g. Example 28) relates to Example 27 and further comprises the model being a security model, and the features being indicative of potential cyber-attacks.

Example 29 is a non-transitory machine-readable storage medium including program code, when executed, to cause a machine to perform the method of any one of the preceding examples (e.g., Examples 1 through 16).

Example 30 is a computer program having a program code for performing the method of any one of examples 1 to 16 when the computer program is executed on a computer, a processor, or a programmable hardware component.

Example 31 is a machine-readable storage including machine readable instructions, when executed, to implement a method or realize an apparatus as in any one of the preceding examples.

Example 32 is a system for enhancing a model for an edge device comprising an apparatus according to any one of examples 18 to 25, and an apparatus according to example 26 or 27.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components.

Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F) PLAs), (field) programmable gate arrays ((F) PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A non-transitory machine-readable storage medium including program code, which when executed by a machine, causes the machine to perform operations for running a model on an edge device, the operations comprising: receiving the model from a centralized server; running the model on the edge device; analyzing data on the edge device to generate features for the model; and transmitting the features from the edge device to the centralized server.

2. The non-transitory machine-readable storage medium of claim 1, wherein the operations further comprise at least one of normalizing, scaling or transforming raw data into the features.

3. The non-transitory machine-readable storage medium of claim 1, wherein the operations further comprise receiving an updated model from the centralized server.

4. The non-transitory machine-readable storage medium of claim 1, wherein the features are generated such that they are non-sensitive.

5. The non-transitory machine-readable storage medium of claim 1, wherein the features are transmitted using a secure communication protocol.

6. The non-transitory machine-readable storage medium of claim 1, wherein transmitting the features further comprises encrypting the features.

7. The non-transitory machine-readable storage medium of claim 1, wherein the model is a security model, and the features are indicative of potential cyber-attacks.

8. The non-transitory machine-readable storage medium of claim 7, wherein the data is analyzed to generate features that are indicative of at least one of call stack anomalies, unusual memory access patterns, rare API calls, execution timing patterns, code injection indicators, or process communication anomalies.

9. A non-transitory machine-readable storage medium including program code, which when executed by a machine, causes the machine to perform operations to maintain a model for an edge device, the operations comprising: receiving features from the edge device; updating the model based on the features using machine learning; and transmitting the updated model to the edge device.

10. The non-transitory machine-readable storage medium of claim 9, wherein the model is a security model, and the features are indicative of potential cyber-attacks.

11. A system for enhancing a model for an edge device, comprising:
an apparatus for using a model on an edge device, comprising:
a communication interface configured to receive the model from a centralized server; processing circuitry configured to run the model on the edge device and to analyze data on the edge device to generate features for the model; wherein the communication interface is further configured to transmit the features from the edge device to the centralized server; and an apparatus for maintaining a model for an edge device, and
an apparatus for maintaining a model for an edge device, comprising:
a communication interface configured to receive features from the edge device; a processing unit configured to update the model based on the features using machine learning; wherein the communication interface is further configured to transmit the updated model to the edge device.

12. The system of claim 11, wherein the processing circuitry of the apparatus for using a model on an edge device is further configured to normalize, scale or transform raw data to generate the features.

13. The system of claim 11, wherein the communication interface of the apparatus for using a model on an edge device is further configured to receive an updated model from the centralized server.

14. The system of claim 11, wherein the processing circuitry of the apparatus for using a model on an edge device is configured to generate the features such that they are non-sensitive.

15. The system of claim 11, wherein the communication interface of the apparatus for using a model on an edge device is configured to transmit the features using a secure communication protocol.

16. The system of claim 11, wherein the communication interface of the apparatus for using a model on an edge device is further configured to encrypt the features.

17. The system of claim 11, wherein the model is a security model and the features are indicative of potential cyber-attacks.

18. The system of claim 11, wherein the processing circuitry of the apparatus for using a model on an edge device is configured to generate features that are indicative of at least one of call stack anomalies, unusual memory access patterns, rare API calls, execution timing patterns, code injection indicators, or process communication anomalies.

19. The system of claim 11, wherein the communication interface of the apparatus for maintaining a model for an edge device is configured to transmit the updated features using a secure communication protocol.

20. The system of claim 11, wherein the communication interface of the apparatus for maintaining a model for an edge device is configured to encrypt the updated features.
